(19) United States
(12) Patent Application Publication
(10) Pub. No.: US 2026/0088423 A1
(43) Pub. Date: Mar. 26, 2026

(54) BATTERY ASSEMBLY FOR POWER EQUIPMENT

(71) Applicant: Honda Motor Co., Ltd., Tokyo (JP)

(72) Inventors: Christopher Kurt Zingelmann, JR., Raleigh, NC (US); Travis Barkey, Greensboro, NC (US); Scott J Kaskawitz, Hillsborough, NC (US); Ayman Zohbi, High Point, NC (US)

(21) Appl. No.: 18/898,459

(22) Filed: Sep. 26, 2024

(51) Int. Cl. H01M 50/249; H01M 50/256; H01M 50/289

(52) U.S. Cl. CPC H01M 50/249; H01M 50/256; H01M 50/289

(57) ABSTRACT

A battery assembly for a power equipment includes a plurality of batteries including at least one first battery and at least one second battery, and a battery frame to hold the plurality of batteries. The battery frame includes a casing retaining the at least one first battery the at least one first battery is non-removably arranged inside the casing. The battery frame further includes at least one track arranged outwardly of the casing and including a first end connected to the casing and a second end disposed distally from the casing. The at least one track defines an elongated slot extending from the first end to the second end. Moreover, the at least one second battery is slidably and removably arranged inside the slot.

### BACKGROUND

The disclosed subject matter relates to a battery assembly for a power equipment. More particularly, the disclosed subject matter relates to a battery assembly for a power equipment and having fixed and swappable batteries.

Power equipment, such as zero turn riding lawnmowers, hedge trimmers, string trimmers, power saws, tillers, snow blowers, portable coolers, E-Bikes, and scooters may be operated by an electric motor. To supply the electric power to the electric motor, the power equipment includes a battery assembly having a plurality of batteries. The overall capacity of the batteries determines run time of any power equipment. However, onboard batteries have a finite run time and do not meet the customer's usage. Swappable batteries, tend to be large and heavy and don't fully utilize the space available.

### SUMMARY

In accordance with one embodiment of the present disclosure, a battery assembly for a power equipment is disclosed. The battery assembly comprises a plurality of batteries including at least one first battery and at least one second battery. The battery assembly further includes a battery frame to hold the plurality of batteries. The battery frame includes a casing retaining the at least one first battery. The at least one first battery is non-removably arranged inside the casing. The battery frame further includes at least one track arranged outwardly of the casing and including a first end connected to the casing and a second end disposed distally from the casing. The at least one track defines an elongated slot extending from the first end to the second end. Moreover, the at least one second battery is slidably and removably arranged inside the slot.

In accordance with another embodiment of the present disclosure, a power equipment is disclosed. The power equipment includes a frame and a battery frame mounted to the frame. The battery frame includes a casing and at least one track arranged outwardly of the casing and including a first end connected to the casing and a second end disposed distally from the casing. The at least one track defines an elongated slot extending from the first end to the second end. The power equipment further includes at least one first battery non-removably arranged inside the casing, and at least one second battery mounted on the at least one track, and slidably and removably arranged inside the slot.

In accordance with yet a further embodiment of the present disclosure a zero-turn lawnmower is disclosed. The lawnmower includes a frame, a plurality of wheels coupled to the frame and arranged to movably support the frame on a surface, and a cutter housing supported on the frame and extending vertically downwardly from the frame. The cutter housing defines a blade chamber. The zero-turn lawnmower further includes a blade arranged, at least partially, inside the blade chamber and rotatably mounted to the cutter housing to rotate about a blade axis. Moreover, the zero-turn lawnmower includes a seat mounted on the frame and extending vertically upwardly from the frame, and a battery frame supported on the frame. The battery frame includes a casing, and at least one track arranged outwardly of the casing and including a first end connected to the casing and a second end disposed distally from the casing. The at least one track defines an elongated slot extending from the first end of the at least one track to the second end of the at least one track. Furthermore, the zero-turn lawnmower includes at least one first battery non-removably arranged inside the casing, and at least one second battery mounted on the at least one track, and slidably and removably arranged inside the slot.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a rear perspective view of a power equipment depicted as a zero-turn lawnmower, in accordance with one embodiment of the present disclosure;

FIG. 2 illustrates a perspective schematic view of a battery assembly having a battery frame and a plurality of batteries including at least one fixed/integrated battery and at least one swappable battery, in accordance with one embodiment of the present disclosure;

FIG. 3 illustrates a perspective view of the battery assembly of FIG. 2 depicting one swappable battery arranged outside a track of the battery frame, in accordance with one embodiment of the present disclosure; and

FIG. 4 illustrates a top perspective view of the battery frame of FIG. 2, in accordance with one embodiment of the present disclosure.

### DETAILED DESCRIPTION OF EXEMPLARY EMBODIMENTS

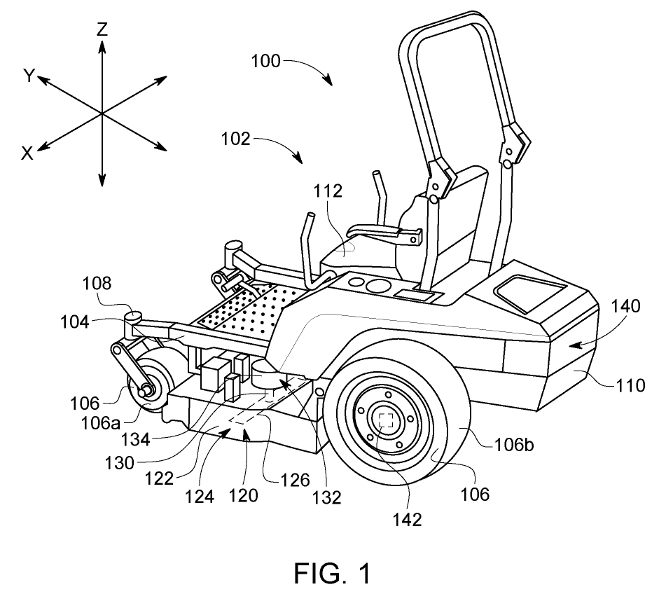

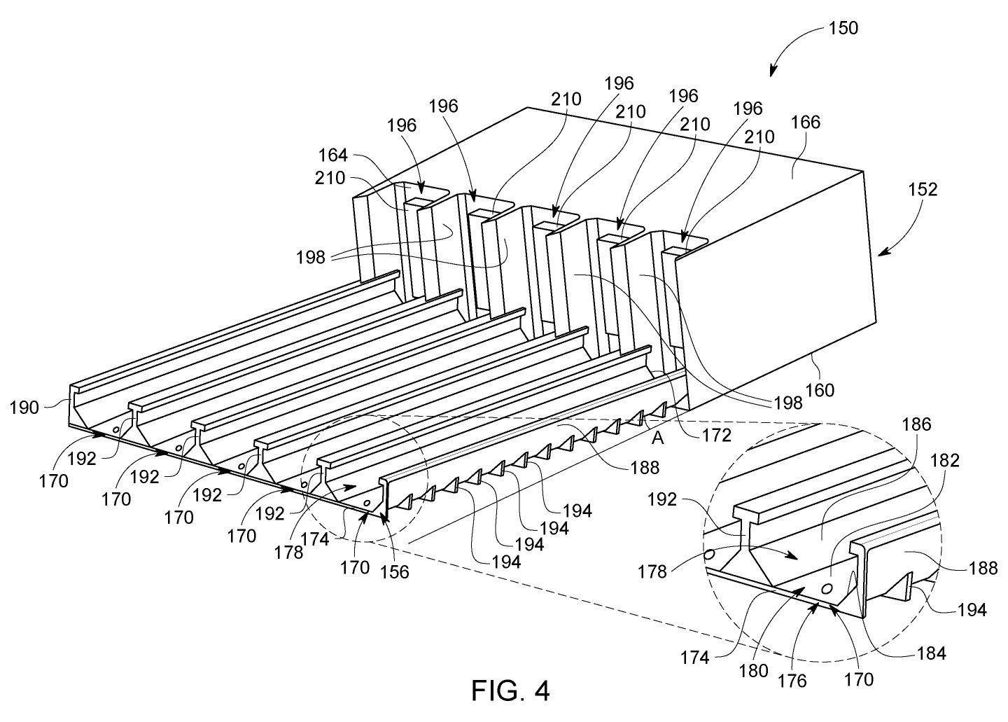

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

FIG. 1 illustrates a power equipment 100 according to an embodiment of the disclosure. In the illustrated embodiment, the power equipment 100 is a zero-turn lawnmower 102, however, it may be appreciated that the power equipment 100 may be a tiller, a trimmer, snow blowers, portable coolers, e-bike, a walk-behind lawnmower, a ride-on lawnmower, a remote-controlled lawnmower, an autonomous lawnmower, or a semi-autonomous lawnmower, or any other similar equipment known in the art. The power equipment 100 may extend along an X-direction, a Y-direction and a Z-direction, with directions being orthogonal to each other. As shown, the power equipment 100 i.e., zero-turn lawn mower 102 including a frame 104 and a plurality of traction members, for example, wheels 106 or tracks, rotatably coupled to the frame 104 and movably supporting the frame 104 on a surface. As shown, the zero-turn lawnmower 102 includes a front end 108 and a rear end 110, with a pair of front wheels 106a arranged proximate to the front end 108 and a pair of rear wheels 106b arranged proximate to the rear end 110. In the illustrated embodiment, diameters of the front wheels 106a are smaller than the diameters of the rear wheels 106b. Also, the zero-turn lawnmower 102, hereinafter simply referred to as lawn mower 102, includes a seat 112 arranged supported on the frame 104 and disposed proximate to the rear end 108 relative to the front end 108. The seat 112 enables a seating of an operator of the lawnmower 102 to facilitate the operator to operate the lawnmower 102.

Further, the lawnmower 102 includes a cutter assembly 120 mounted to the frame 104 and arranged between the front end 108 and the seat 112 in a longitudinal direction of the lawnmower 102. As shown, the cutter assembly 120 extends downwardly of the frame 104, while the seat 112 extends upwardly of the frame 104. The cutter assembly 120 includes a cutter housing 122 including a blade chamber 124. The cutter housing 122 may be referred to as a mower deck or as a cutter deck or as a deck. As shown, the cutter assembly 120 includes a blade 126 rotatably mounted to the cutter housing 122 and arranged at least partially inside the blade chamber 124 and a blade shaft 130 connecting the blade 126 and a power source assembly 132.

The power source assembly 132 is configured to selectively rotate the blade shaft 130 and the blade 126 about a blade axis which extends in the Z-direction. The power source assembly 132 includes a blade motor 134 and a battery assembly 140 powering by the blade motor 134 to rotate the blade 126. Moreover, the power source assembly 132 may include a propulsion motor 142 powered by the battery assembly 140. A transmission (not shown) may operatively connect the propulsion motor 142 to the rear wheels 106b to operate the wheels 106. In an embodiment, the transmission may be omitted. Also, the battery assembly 140 is mounted to the frame 104, and is arranged at the rear end 110 of the lawnmower 102.

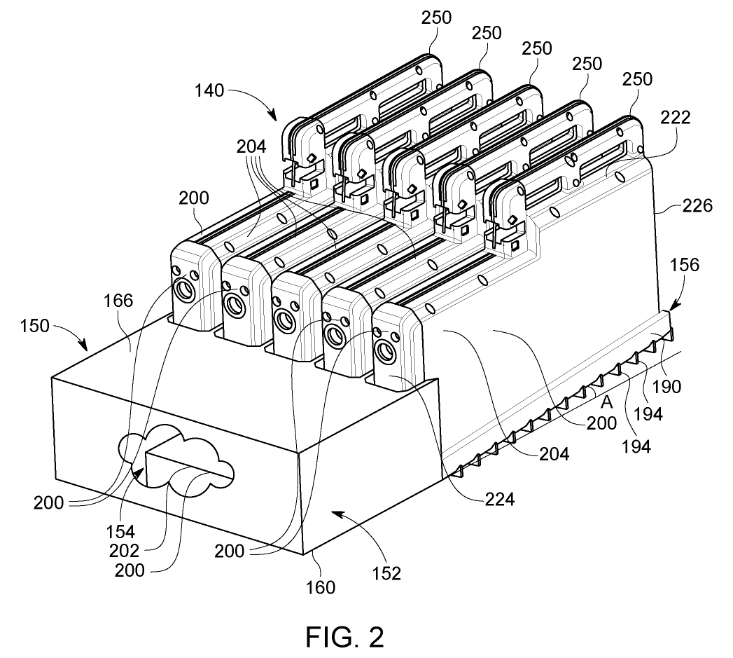

Referring to FIGS. 2, 3, and 4, the battery assembly 140 includes a battery frame 150 and a plurality of batteries 200 arranged supported on the battery frame 150. As shown, the battery frame 150 includes a casing 152 that defines a chamber 154 to store at least one first battery 202 of the plurality of batteries 200, and a battery bay 156 attached to the casing and arranged outside the casing 152 to hold at least one second battery 204 of the plurality of batteries 200. The at least one first battery 202 is a fixed/integrated battery and is fixedly arranged inside or integrated within the casing and is difficult to be removed to change/replace with another identical or similar battery, while the at least one second battery 204 is a swappable battery which is adapted to be exchanged with another identical/similar battery in case of a discharge of the second battery 204. Accordingly, the at least one first battery 202 is charged while being disposed/arranged inside the casing, while the at least one second battery 204 is replaced/exchanged/swapped with another identical second battery 204 in case of a discharge of the at least one second battery 204. By having one or more integrated batteries, the size and weight of the swappable batteries can be reduced. Accordingly, when longer runtime is needed, fully charged swappable batteries are replaced with the depleted swappable batteries.

As shown in FIGS. 2-4, the casing 152 includes a floor 160, a plurality of sidewalls including a first sidewall 164, and a roof 166 arranged supported on the sidewalls and disposed opposite to and facing the floor 160. The chamber 154 is between the floor 160, the sidewalls, and the roof 166 to provide a space for mounting the at least one first battery 200 inside the casing 152. Further, the battery bay 156 is attached to the first sidewall 164, and extends outwardly of the casing 152. In the illustrated embodiment, the battery bay 156 includes a plurality of tracks 170 arrayed along a length of the first sidewall 164 and configured to receive and hold the plurality of second batteries 204. Although, the plurality of tracks 170 is shown and contemplated, it may be appreciated that the battery bay 156 may include a single track 170 to removably hold and retain a single second battery 204.

As shown, each track 170 includes a substantially U-shape having a first end 172 attached to the first sidewall 164 and a second end 174 arranged distally from the first sidewall 164. Although the track 170 having the U-shape is shown and contemplated, it may be envisioned that the track 170 may include any other suitable shape, such as, but not limited to, V-shape, L-shape, or any other shape known in the art that facilitates a retention of a second battery 204 inside the track 170. In the illustrated embodiment, the track 170 includes a base structure 176 defining an elongated slot 178 to slidably and removably receive and retain the second battery 204. The elongated slot 178 extends from a free end 174 (i.e., second end 174) of the track 170 to the first sidewall 164 with an opening 180 of the slot 178 arranged at the free end 174 of the track 170. The base structure 176 includes a bottom wall 182 and a pair of sidewalls 184, 186 extending substantially vertically from the bottom wall 182. In the illustrated embodiment, the sidewalls 184, 186 extend obliquely outwardly and upwardly from the bottom wall 182. Accordingly, a distance between the sidewalls 184, 186 increases in a vertical direction away from the bottom wall 182.

Further, the battery bay 156 includes a plurality of walls extending along the lengths of the tracks 170 from the first end 172 to the second 174 and arrayed along the length of the first sidewall 164 of the casing 152. As illustrated, the plurality of walls includes a pair of end walls 188, 190 arranged at lateral ends of the battery bay 156, and at least one partition wall 192 arranged between the end walls 188, 190 and separating adjacent tracks 170 from each other. Although, a number of tracks 170 are shown and contemplated, it may be appreciated that the battery frame 150 may include a single track 170, and in such a case, the partition walls 192 may be omitted. Further, the battery bay 156 may include a plurality of fins 194 connected to a lower surface of the base structure 176 to enable an improved transfer of heat from the second batteries 204 arranged inside the tracks 170.

Moreover, each track 170 is arranged proximate to the floor 160 and extends from the first sidewall 164 such that the track 170 extends obliquely upwardly relative to the floor 160 of the casing 152. Accordingly, the first end 172 of the track 170 is arranged at a lower elevation than the second end 174 of the track 170. In the illustrated embodiment, the bottom wall 182 of the base structure 176 of the track 170 is arranged at an acute angle ‘A’ relative to the floor 160 of the casing 152. The downward inclination of the track 170 from the second end 174 towards the casing 152 facilitates an easy sliding of the second battery 204 inside the track 170 once inserted through the opening 180. In some embodiments, the inclination of the track 170 between the first end 172 and the second end 174 is omitted, and the bottom wall 182 of the base structure 176 of the track is aligned i.e., planer with the floor 10 the casing 152.

Further, the casing 152 i.e., the first sidewall 164 defines at least one groove 196 extending vertically from the roof 166 of the casing 152 to the floor 160 i.e., the battery bay 156 of the casing 152. In the illustrated embodiment, the casing 152 defines the plurality of grooves 196 that intersects with the plurality of slots 178 of the plurality of tracks 170. It may be appreciated that the slots 178 extend in a substantially horizonal direction, while the grooves 196 extend in a substantially vertical direction, with one track 170 i.e., slot 178, being associated with a single/one groove 196 that is arranged aligned with the slot 178 i.e., track 170. Moreover, adjacent grooves 196 are separated from each other via a separation wall 198 that extends along a height of the first sidewall 164. The groove 196, the track 170, and associated slot 178 facilitate in holding the second battery 204 in position with the battery frame 150.

Further, to facilitate the electrical connection of the second battery 204 with the at least one first battery 202, the battery assembly 140 includes at least one electrical connector, for example, first electrical connector 210, adapted to be coupled to an electrical connector, for example, a second electrical connector 212, of the second battery 204. As shown, the electrical connector 210 is arranged at the first end 172 of the track 170, inside the groove 196, and is coupled to the casing 152. It may be appreciated that a single first electrical connector 210 is arranged inside a single groove 196 to enable an electrical connection of a second battery 204 that is arranged/position inside an aligned track 170 i.e., slot 178. In an embodiment, the first electrical connector 210 may include a plug, while the second electrical connector 212 includes a socket adapted to receive the plug. Alternatively, the first electrical connector 210 may include a plug and the second electrical connector 212 may include a socket.

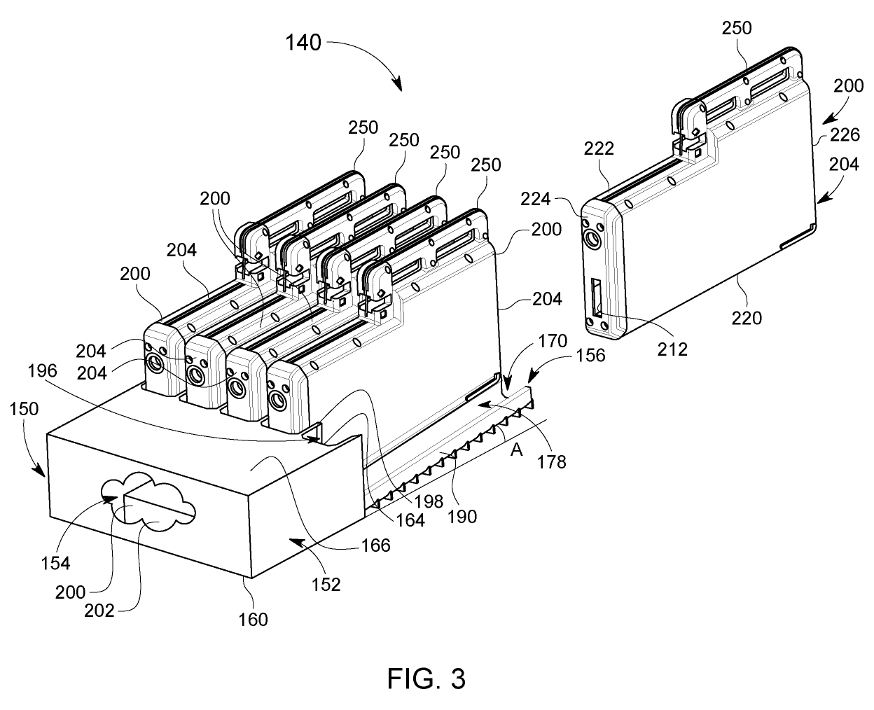

Referring back to FIG. 3, the second battery 204 includes a first longitudinally extending end 220, a second longitudinally extending end 222, a first laterally extending end 224, and a second laterally extending end 226 arranged opposite to the first laterally extending end 224. The longitudinally extending ends 220, 222 extend along the length of the track 170 from the first second end 174 of the track 170 to the first end 172 of the track 170 when the second battery 204 is arranged inside the track 170. As shown, the first longitudinally extending end 220 is arranged inside the slot 178 and connected to the base structure 176 when the second battery 204 is arranged inside the track 170. Moreover, the second battery 204 includes a handle 250 arranged at the second end 222 i.e., upper end of the second battery 204 and extending in the longitudinal direction.

It should be noted that the battery assembly 140 as a whole may be oriented in any position. The mix of terms such as “horizontal” and “vertical” motion should not bind the present disclosure in one specific orientation and still remain with the scope of the present disclosure. In particular, the exemplary X-direction, Y-direction and Z-direction described above may represent a three-dimensional coordinate system for the lawnmower as an exemplary power equipment. However, alternate embodiments of the power equipment may be described by a three-dimensional XYZ coordinate system that is rotated relative to the XYZ coordinate system shown in FIG. 1. For example, instead of the Z-direction extending in a vertical direction and the X-direction and Y-direction extending in a horizontal direction as shown in FIG. 1, the XYZ coordinate system may be misaligned with respect to the vertical and horizontal directions.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. A battery assembly for a power equipment, the battery assembly comprising:
a plurality of batteries including at least one first battery and at least one second battery; and
a battery frame to hold the plurality of batteries, the battery frame including
a casing retaining the at least one first battery, wherein the at least one first battery is non-removably arranged inside the casing, and
at least one track arranged outwardly of the casing and including a first end connected to the casing and a second end disposed distally from the casing, wherein the at least one track defines an elongated slot extending from the first end to the second end, wherein the at least one second battery is slidably and removably arranged inside the slot.

2. The battery assembly of claim 1, wherein the at least one track includes a U-shape.

3. The battery assembly of claim 1, wherein the at least one track extends obliquely and outwardly from the casing such that the first end is arranged at a lower elevation than the second end.

4. The battery assembly of claim 1, wherein the battery frame includes a plurality of fins connected to the at least one track.

5. The battery assembly of claim 1 further including at least one electrical connector mounted to the casing, wherein the at least one electrical connector is arranged at the first end of the at least one track and aligned to the slot to enable an electrical connection with the at least one second battery arranged inside the slot of the at least one track.

6. The battery assembly of claim 1, wherein the at least one second battery includes a first end adapted to be arranged inside the slot, a second end arranged opposite to the first end, and a handle arranged at the second end to enable a user to hold the at least one second battery.

7. The battery assembly of claim 1, wherein the casing defines at least one vertically extending groove arranged aligned with the at least one slot and adapted to receive a portion of the at least one second battery when arranged inside the at least one slot.

8. A power equipment, comprising:
a frame;
a battery frame mounted to the frame, the battery frame including
a casing, and
at least one track arranged outwardly of the casing and including a first end connected to the casing and a second end disposed distally from the casing, wherein the at least one track defines an elongated slot extending from the first end to the second end;
at least one first battery non-removably arranged inside the casing; and
at least one second battery mounted on the at least one track, and slidably and removably arranged inside the slot.

9. The power equipment of claim 8, wherein the at least one track includes a U-shape.

10. The power equipment of claim 8, wherein the at least one track extends obliquely and outwardly from the casing such that the first end is arranged at a lower elevation than the second end.

11. The power equipment of claim 8, wherein the battery frame includes a plurality of fins connected to the at least one track.

12. The power equipment of claim 8, wherein the battery frame further includes at least one electrical connector mounted to the casing, wherein the at least one electrical connector is arranged at the first end of the at least one track and aligned to the slot to enable an electrical connection with the at least one second battery arranged inside the slot of the at least one track.

13. The power equipment of claim 8, wherein the at least one second battery includes a first end adapted to be arranged inside the slot, a second end arranged opposite to the first end, and a handle arranged at the second end to enable a user to hold the at least one second battery.

14. The power equipment of claim 8, wherein the casing defines at least one vertically extending groove arranged aligned with the at least one slot and adapted to receive a portion of the at least one second battery when arranged inside the at least one slot.

15. A zero-turn lawnmower, comprising:
a frame;
a plurality of wheels coupled to the frame and arranged to movably support the frame on a surface;
a cutter housing supported on the frame and extending vertically downwardly from the frame, the cutter housing defines a blade chamber;
a blade arranged, at least partially, inside the blade chamber and rotatably mounted to the cutter housing to rotate about a blade axis;
a seat mounted on the frame and extending vertically upwardly from the frame;
a battery frame supported on the frame and includes
a casing, and
at least one track arranged outwardly of the casing and including a first end connected to the casing and a second end disposed distally from the casing, wherein the at least one track defines an elongated slot extending from the first end of the at least one track to the second end of the at least one track;
at least one first battery non-removably arranged inside the casing; and
at least one second battery mounted on the at least one track, and slidably and removably arranged inside the slot.

16. The zero-turn lawnmower of claim 15, wherein the at least one track includes a U-shape.

17. The zero-turn lawnmower of claim 15, wherein the at least one track extends obliquely and outwardly from the casing such that the first end is arranged at a lower elevation than the second end.

18. The zero-turn lawnmower of claim 15, wherein the battery frame further includes at least one electrical connector mounted to the casing, wherein the at least one electrical connector is arranged at the first end of the at least one track and aligned to the slot to enable an electrical connection with the at least one second battery arranged inside the slot of the at least one track.

19. The zero-turn lawnmower of claim 15, wherein the at least one second battery includes a first end adapted to be arranged inside the slot, a second end arranged opposite to the first end, and a handle arranged at the second end to enable a user to hold the at least one second battery.

20. The zero-turn lawnmower of claim 15, wherein the casing defines at least one vertically extending groove arranged aligned with the at least one slot and adapted to receive a portion of the at least one second battery when arranged inside the at least one slot.
